(19) United States
(12) Patent Application Publication
(10) Pub. No.: US 2007/0096403 A1
(43) Pub. Date: May 3, 2007

(54) Apparatus and method for fabricating optical fiber preform.

(75) Inventors: Sanket Shah, Aurangabad (IN); Chandraveer Singh, Aurangabad (IN); Nitin Shinde, Aurangabad (IN)

Correspondence Address: JAMES RAY & ASSOCIATES, 2640 Pitcairn Road, Monroeville, PA, 15146, US

(73) Assignee: STERLITE OPTICAL TECHNOLOGIES LTD

(21) Appl. No.: 11/638,885

(22) Filed: Dec. 14, 2006

(30) Foreign Application Priority Data
Mar. 6, 2006 (IN) 313/MUM/2006

(51) Int. Cl. B23B 31/30; G02B 6/02; C03B 37/018; B32B 17/06; B23B 31/10; B32B 9/00

(52) U.S. Cl. 279/4.01; 65/417; 428/428; 385/123

(57) ABSTRACT

A rotary seal capable of joining a stationary member with a rotating member is provided, wherein the rotary seal comprises a body having a central hole therethrough, wherein said central hole has stepwise reducing diameter so as to form two part central hole, wherein front part of said central hole has higher inner diameter and rear part of said central hole has lower inner diameter, wherein said front part forms a seat with said rear part of said central hole, wherein said front part of said central hole is capable of accommodating at least one sealing member, and said sealing member is made to sit onto said seat by a screwing member, which when fixed onto body fits into front part of said central hole, and said rear part of said central hole is capable of accommodating connecting member of said stationary member. An apparatus comprising the rotary seal is also provided.

### FIELD OF THE INVENTION

The present invention relates to an apparatus and method for fabricating optical fiber preform. Particularly, it relates to a rotary sealing mechanism for apparatus for fabricating optical fiber preform, and apparatus comprising the same. The present invention also relates to method for fabricating optical fiber preform employing apparatus comprising rotary sealing mechanism, and optical fiber produced from such preform, wherein the fiber produced has low attenuation, preferably less than about 0.35 dB/Km in the wavelength range varying from about 1300 nm to about 1625 nm.

### BACKGROUND OF INVENTION

Optical fibers are inherently versatile as a transmission medium for all forms of information, be it voice, video or data. The primary object of telecommunication industry is to transmit greater amount of information, over longer distances, in shorter period of time. This object can be fulfilled with the optical fibers provided it has low optical attenuation loss in the wavelength ranges varying from about 1300 nm to about 1625 nm.

Optical fiber is drawn from optical fiber preform. The optical fiber preform generally comprises a central core and an outer cladding. The core rod itself comprises a core and part of cladding of the fiber preform. Conventionally, the core rod can be prepared by any known method, for example by Atmospheric Chemical Vapor Deposition (ACVD) method, wherein the soot is deposited during the deposition process step on the cylindrical member (also referred as target rod or mandrel) to form soot porous body. In this method, the soot deposition is accomplished by traverse motion of the cylindrical member over the burners or vice versa. The initial soot deposition comprises dopant chemicals to increase refractive index of the core and dopant chemicals are terminated after desired core diameter is obtained. The deposition process continues until the required dimension of the soot porous body is attained for meeting desired core diameter in the optical fiber preform and the desired core-clad diameter ratio in the fiber. A typical single mode optical fiber may have core of about 8-10 μm in diameter and clad of about 125 μm in diameter. After completion of soot deposition, the cylindrical member is removed from the soot porous body to form hollow cylindrical soot porous body defining a capillary at the center [herein after referred to as hollow soot porous body]. A glass plug is inserted into the end remote from the handle of the hollow soot porous body. The hollow soot porous body is moved into a sintering furnace, wherein this hollow soot porous body is first dehydrated and then sintered (also known as vitrification or consolidation) in a chlorine and helium atmosphere to form optical fiber preform at about 1500° C.

The dehydration and sintering processes can be carried out by any method known in the art. Preferably, it can be carried out inside specially built furnaces that are equipped with one or more heating elements and gas input mechanisms. The dehydration and sintering processes comprise inserting the hollow cylindrical soot porous body into a sintering furnace and subjecting it to a temperature regime under controlled chemical environment to form sintered glass preform. The chemical environment necessary for dehydration is provided with the help of gases that promote dehydration. The chemical environment that is necessary for sintering is provided with gases that are inert and have high thermal conductivity.

The sintered glass preform with capillary is subjected to, after removal from the sintering furnace to a process step of rod draw to form a plurality of core rods having predetermined diameter. During this process step, vacuum is applied to the capillary to result in collapsing of the capillary, which gets closed due to the glass surface tension; relative viscosities of core and cladding. The application of vacuum increases the speed of collapsing step and it also facilitates removal of gases formed in the preform capillary during the rod draw step.

The core rod drawn may be, if desired, subjected to a process step of overcladding by depositing soot over the core rod to form soot porous body having solid core rod. The soot porous body may be subjected to process steps of dehydration and consolidation to form optical fiber preform (called daughter preform). Accordingly, the optical fiber can be drawn either directly from the mother preform or the daughter preform.

As described hereinabove the sintered preform with uncollapsed capillary therein is removed from the furnace and then in the separate step of rod draw, it is collapsed under negative pressure or vacuum. This step of collapsing capillary in rod draw step increases the chances of capillary contamination. The preform capillary forms the center of optical fiber core, through which most of the light travels. The performance of the optical fiber used for transmission is primarily determined by the optical attenuation loss and dispersion in the optical fiber. The contamination or deformation of any kind of the capillary has a severe negative impact on the optical fiber attenuation drawn therefrom. It is desired that the capillary should not be exposed to the ambient atmosphere at all.

The U.S. Pat. No. 4,251,251 discloses a method so that the capillary is not exposed to the ambient atmosphere at all. According to '251, the process steps of making the preform are carried out in the order namely:
1. Deposition;
2. Removal of cylindrical member;
3. Sintering and collapsing the capillary to get solid glass preform having collapsed capillary therein;
4. Rod drawing from the so formed solid glass preform;
   prevents exposure of capillary to the ambient atmosphere. The capillary is collapsed simultaneously with the sintering of hollow soot porous body or during the step of sintering without removing it from the sintering furnace. Vacuum is applied to the capillary of the hollow soot porous body. The capillary collapses during the sintering step due to glass surface tension; relative viscosities of core and cladding layer.

The U.S. Patent '251 also discloses that in order to collapse the capillary in sintering step itself, higher temperature is required than that needed for only sintering the hollow soot porous body. This temperature is higher than the softening point of glass.

Even at the softening point of glass, the glass gets deformed and elongated due to gravity. The elongation distorts the preform shape and, hence the refractive index profile. This deformation of refractive index profile and shape results in unwanted attenuation increase or other waveguide parameters of the optical fiber. For example, the clad to core diameter ratio may vary if the shape of the resulting preform is deformed in sintering. This results in variations in the core diameter of the resulting optical fiber drawn therefrom. The variations in core diameter results in change of cutoff wavelength value from the desired value. The variation in core diameter may also result in elevated attenuation in the optical fiber. The U.S. Patent '251 does not provide any remedy for these problems.

It is observed that rotating the hollow soot porous body about its longitudinal axis at a predetermined rotational speed solves the above-mentioned problem. The centrifugal acceleration due to rotation nullifies the gravity effect and eliminates the distortion. The hollow soot porous preform rotation about its longitudinal axis of symmetry allows for proper collapse of the capillary and other problems related with unsymmetrical collapse are taken care of.

The hollow soot porous body with capillary, which is suspended in the sintering furnace, is rotated along its longitudinal axis of symmetry and also the soot porous preform capillary is connected to a stationary vacuum pump through a pipe. A connector [herein after referred to as rotary sealing mechanism] for connecting a stationary pipe from the vacuum pump and the rotating soot porous preform capillary is needed.

The U.S Pat. No. 4,347,069 discloses a rotary seal at the junction of stationary member connecting the supply source of vapor stream and the rotating preform tube. The rotary seal according to this patent consists of locating an end of the rotating member inside an end of another rotating member and positioning two washers or O-rings between the two ends of the rotating members. Another end of another rotating member is then made to sit in an end cap provided with two inlets, one inlet for receiving the tube connected to supply source of vapor stream and another inlet for receiving the tube connected to supply source of oxygen.

This rotary seal of '069 overcomes problem of early wear out of washers or O-rings by connecting one end of rotating member connected to rotating preform tube with one end of another rotating member. However, another end of said another rotating member, which constitutes an additional part of the apparatus is still located onto one end of stationary member connected to supply source of vapor stream which is fitted inside said another end of said another rotating member [an additional part of the apparatus] in the manner known in the prior art.

This particular rotary seal as disclosed in the '069 can be used for connecting the stationary vacuum tube and the rotating hollow soot porous body. However, the inventors of the present invention faced limitations described below.

Even the rotary seal of above-referred patent suffers from the main problem of early wear out of washers or O-rings.

As the amount of heat to which the rotary seal will be exposed during the simultaneous sintering and collapsing of the soot porous body is quite high than of the amount of heat during the preform fabrication in accordance with the method described in the said document '069. Therefore, it has been observed by the inventors of the present invention that the O-rings wear out during a single operation also itself, because the O-rings are positioned inside the rotary seal. The wearing out of O-rings during the sintering and collapsing of the soot porous body is observed to cause following problems:
a. Certain particles are generated as the O-rings wear out due to heat and friction against the stationary/rotating members (vacuum tube/soot porous body handle) which plunge into the capillary of the soot porous body thereby resulting in contamination of the capillary and, hence increase in the attenuation level of the resulted optical fiber drawn therefrom.
b. Further, wearing of O-rings also leads to leakage of vacuum in the soot porous body capillary thereby causing contaminate present in the ambient atmosphere to enter in the capillary of the soot porous body which in-turn further contaminates it. This contamination results in further increase in the attenuation level and thereby makes the resulting optical fiber, drawn therefrom, unsuitable for any use.
c. Still further, the vacuum leakage due to rupture or wearing out of the O-rings has been observed to result in partial or incomplete closure of capillary and/or formation of bubbles therein.
d. O-rings have been observed to inhibit smooth rotation of the tube thereby result in friction against the stationary and rotating members which has been found to be responsible for early wearing out of the O-rings.
e. As O-rings tightly fit only onto one surface just like a rubber band, the complete sealing cannot be achieved.
f. Still another problem of the rotary seal of said patent '069 is that it calls for additional supply of oxygen gas that's too at a very high pressure at least higher than the pressure of the vapor stream. This additional supply of oxygen gas at a very high pressure is provided to achieve pressure differential in the cavity created between stationary end cap and said another [additional] rotating member to avoid or inhibit leakage of toxic vapor stream in the environment as and when there is a leakage due to early wear out of washer or O-rings provided between said another end of said another rotating member which constitutes an additional part of the apparatus and the stationary member connected to source of supply of vapor stream.
g. Further, the O-rings have been observed to become loose due to overheating or friction or overuse causing leakage of atmospheric gases into the tube. In such situation, when preparing the preform employing apparatus of '069, no action can be taken in running process to check the leakage. It becomes inevitable to abandon the process altogether, resulting in consumption of time and material loss.

Therefore, it is clear from the foregoing description that even the rotary seal provided by said US patent '069 suffers from various disadvantages, drawbacks and limitation, and in-addition it also requires provision of two additional parts—a) said another rotating member and b) said end cap, and additionally it also requires i) additional supply source of oxygen and ii) additional supply of oxygen gas iii) that's too at a very high pressure thereby resulting in increase in cost of apparatus and cost of production of optical fiber preform, but it still suffers from the main problem of leakage of rotary seal at the junction of rotating member and stationary member thereby making the rotary seal of said patent '069 and the apparatus comprising the same and the method employing the same highly un-satisfactory and highly un-economical in-addition to being complicated due to precise provision of said end cap to achieve the pressure differential.

Further, in case of leakage, not only the toxic vapour stream will come in contact with the environment, but also the oxygen gas, that's too at a very high pressure, which in-turn even in PPM level will cause damage to the skilled persons operating the system and in the surrounding area in-addition to very high risk of fire due to leakage of oxygen at a very high pressure.

It has also been observed that due to leakage of commonly available washers or O-rings, the oxygen which is supplied at a very high pressure, dilutes the vapour stream entering the rotating preform tube thereby resulting in production of preform having undesired characteristics.

It has also been observed that the rotary seal of US patent '069 is not suitable for employing it in the collapsing process step, because the principle of pressure differential does not work when the stationary member is connected to source of vacuum.

Therefore, the rotary seal as disclosed in '069 cannot be used for connecting the stationary vacuum pump and hollow soot porous body capillary, particularly when simultaneous sintering of the hollow soot porous body and collapsing of the capillary of the hollow soot porous body is desired.

### NEED OF THE INVENTION

Accordingly, there is still a need to have an improved rotary sealing mechanism for apparatus for fabricating optical fiber preform so that the apparatus comprising the same becomes suitable for a process for collapsing of capillary in the hollow soot porous body and particularly for a process comprising simultaneous sintering of the hollow soot porous body and collapsing of the capillary therein, and at the same time it neither suffers, at least, from majority of above described disadvantages, drawbacks and limitations of the prior art, nor suffers from the main problem of leakage of rotary sealing mechanism, as it has been observed in the rotary sealing mechanism of the prior art due to O-ring seal rupture at the junction of rotating member and stationary member, thereby making the rotary sealing mechanism thus developed and the apparatus comprising the same and the methods employing such apparatus highly satisfactory and highly economical in-addition to being easy to fabricate and easy to employ in the presently available apparatus for producing the optical fiber preform.

### OBJECTS AND ADVANTAGES OF THE INVENTION

The main object of the present invention is to provide an improved rotary sealing mechanism for apparatus for fabricating optical fiber preform, wherein apparatus is suitable for a process of collapsing of capillary in the hollow soot porous body and particularly for a process comprising simultaneous sintering of the hollow soot porous body and collapsing of the capillary therein, and at the same time it neither suffers, at least, from majority of above described disadvantages, drawbacks and limitations of the prior art, nor from the main problem of leakage of rotary sealing mechanism, and hence the rotary sealing mechanism and the apparatus comprising the same and the methods employing such apparatus is highly satisfactory and highly economical in-addition to being easy to fabricate and easy to employ in the presently available apparatus for producing the optical fiber preform.

The another main object of the present invention is to provide an improved rotary sealing mechanism and apparatus comprising the same which is suitable for avoiding and inhibiting leakage of vacuum or vapor stream and/or mixing of environmental gases with the vapor stream and/or mixing of toxic gases in the environment at the junction of stationary member connected to the vacuum pump or to supply source of vapor stream and the rotating member connected to the rotating hollow soot porous body preform or rotating preform tube thereby making the process more safer and more economical.

Another object of this invention is to provide an improved rotary seal and apparatus comprising the same which is suitable for a) depositing the soot particles inside the rotating preform tube and also for b) collapsing process step for causing collapse of capillary in the soot porous preform and at the same time does not suffer from above described disadvantages, drawbacks and limitations of the prior art thereby making the disclosed rotary sealing mechanism versatile and widely applicable.

Still another object of this invention is to provide an improved rotary seal and apparatus comprising the same which does not require additional rotating member, additional supply source of oxygen and additional oxygen supply and at the same time does not suffer from the main problem of leakage of the seal at the junction of rotating member and stationary member thereby making the rotary seal and the apparatus comprising the same and the method employing the same highly productive, highly satisfactory and highly economical in-addition to being easy to fabricate and easy to employ in the presently available apparatuses for producing the optical fiber preform.

Yet another object of this invention is to provide an improved rotary seal and apparatus comprising the same which does not suffer from the problem of early wear out of sealing member due to constant rotation of rotating member against stationary member thereby avoiding and inhibiting leakage of vacuum to make the process more effective and more productive.

Yet another object of the present invention is to provide a method for fabricating optical fiber preform by employing the apparatus comprising improved rotary sealing mechanism in accordance with the present invention.

It is yet another object of the present invention to provide an optical fiber obtained from the optical fiber preform fabricated by employing the apparatus comprising improved rotary sealing mechanism in accordance with the present invention, wherein the fiber thus produced is characterized by its suitability of use in the wavelength range varying from about 1300 nm to about 1625 nm, and having an absorption loss less than or equal to about 0.35 dB/Km at wavelength ranges varying from about 1300 nm to about 1625 nm.

Other objects, advantages and preferred embodiments of the present invention will be more apparent when the following description is read in conjunction with the accompanying drawings which are not intended to limit the scope of this invention.

### BRIEF DESCRIPTION OF THE ACCOMPANYING FIGURES

FIG. 1A is a schematic representation of deposition process in accordance with known Atmospheric Chemical Vapor Deposition (ACVD) method.

FIG. 1B is a schematic representation of the hollow soot porous body with capillary therethrough connected to preform handle in accordance with the present invention.

FIG. 1C shows cross-sectional view of the hollow soot porous body produced in accordance with known Atmospheric Chemical Vapor deposition method.

FIG. 1D shows a preform handle for the fabrication of hollow soot porous body shown in FIG. 1B in accordance with the present invention.

FIG. 2a shows exploded cross-sectional view of the rotary sealing mechanism in accordance with one of the preferred embodiments of the present invention.

FIG. 2b shows enlarged cross-sectional view of the rotary sealing mechanism connected to rotating member on one end and stationary member on another end in accordance with one of the preferred embodiments of this invention.

FIG. 3 illustrates exploded cross-sectional view of the rotary sealing mechanism in accordance with another preferred embodiment of the present invention.

FIG. 4 illustrates exploded cross-sectional view of the rotary sealing mechanism in accordance with still another preferred embodiment of the present invention.

FIG. 5 illustrates exploded cross-sectional view of the rotary sealing mechanism in accordance with yet another preferred embodiment of the present invention, wherein a cooling member is provided for cooling the sealing members of the rotary sealing mechanism of the present invention.

FIG. 6 is a schematic representation of the apparatus having rotary sealing mechanism in accordance with one of the preferred embodiments of the present invention for simultaneous sintering and collapsing of the hollow soot porous preform.

FIG. 7 illustrates top-perspective view of a sealing member in accordance with first preferred embodiment of the present invention.

FIG. 8a illustrates of overall and cross sectional view of sealing member in accordance with one of the preferred embodiments of the present invention.

FIG. 8a illustrates overall and cross sectional view of sealing member in accordance with another preferred embodiment of the present invention.

### BRIEF DESCRIPTION OF THE INVENTION

Accordingly, the present invention relates to a rotary seal capable of joining a stationary member [connection to vacuum pump tube] with a rotating member [rotating handle of hollow soot porous body or rotating handle of preform tube] comprising a body having a central hole therethrough, wherein said central hole has stepwise reducing diameter so as to form two part central hole, wherein front part of said central hole has higher inner diameter and rear part of said central hole has lower inner diameter, wherein said front part forms a seat with said rear part of said central hole, wherein said front part of said central hole is capable of accommodating at least one sealing member, and said sealing member is made to sit onto said seat by a screwing member, which when fixed onto body fits into front part of said central hole, and said rear part of said central hole is capable of accommodating connecting member of said stationary member [connection to vacuum pump tube].

In accordance with present invention, the sealing member has a [central] hole therethrough which essentially has lower inner diameter than the inner diameter of said rear part so that a part of said sealing member projects into said central hole of the rotary seal to provide air-tight sealing between stationary rotary seal and rotating member [rotating handle of hollow soot porous body or rotating handle of preform tube] in front part of said central hole of the rotary seal.

In one embodiment, the present invention also relates to an apparatus for fabricating the preform wherein the apparatus comprises present rotary seal.

In another embodiment, the present invention relates to a method for fabricating the preform employing the apparatus comprising present rotary seal.

### DETAILED DESCRIPTION AND PREFFERED EMBODIMENTS OF THE INVENTION

Reference will now be made in detail to the present preferred embodiments of the invention, examples of which are illustrated in the accompanying drawings, which are not intended to limit scope of the present invention. Whenever possible, the same reference numerals will be used throughout the description to refer to the same or like parts of the invention.

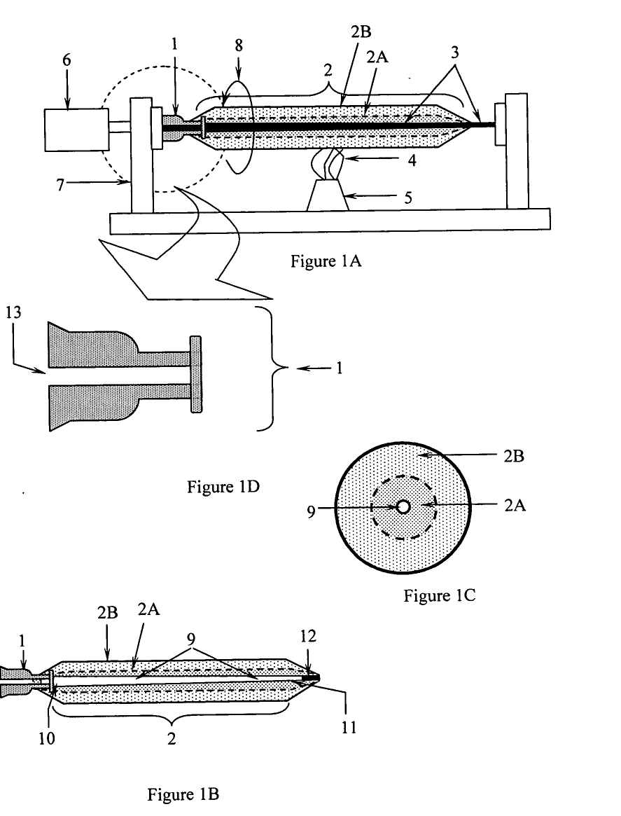

The optical fiber preform may be prepared by any of the conventionally known processes. However, in accordance with one of the preferred embodiments of the present invention, the hollow soot porous body 2, as exemplarily illustrated in FIG. 1B, is formed by depositing chemically reacting at least some of the glass-forming compounds of a moving fluid mixture in an oxidizing medium (preferably a hydro-oxy flame) to form a silica-based reaction product. At least a portion of this reaction product is directed toward a cylindrical member, to form a soot porous body. The method of forming soot porous body described above is known as Atmospheric Chemical Vapor Deposition method or simply ACVD.

As illustrated in accompanying FIG. 1A a cylindrical member 3 is inserted through a glass body such as hollow or tubular handle 1 [FIG. 1D] and mounted on a lathe. The lathe is designed to rotate, by use of rotating means 6 and translate either cylindrical member 3 and/or the soot-generating burner 5 in close proximity with each other. As cylindrical member 3 is rotated and translated, silica-based reaction product 4, known as soot, is directed towards cylindrical member 3. At least a portion of soot 4 is deposited on cylindrical member 3 and on a portion of handle 1 to form a soot porous body which when cylindrical member 3 is removed is referred to as hollow soot porous body 2. The soot 4 may contain some concentration of a suitable dopant (preferably GeCl₄) used to increase the refractive index of the glass.

Once the desired quantity of soot is deposited on the cylindrical member 3, soot deposition is terminated and the cylindrical member 3 is removed from soot porous body to result in the formation of a hollow soot porous body 2having a capillary 9 therein.

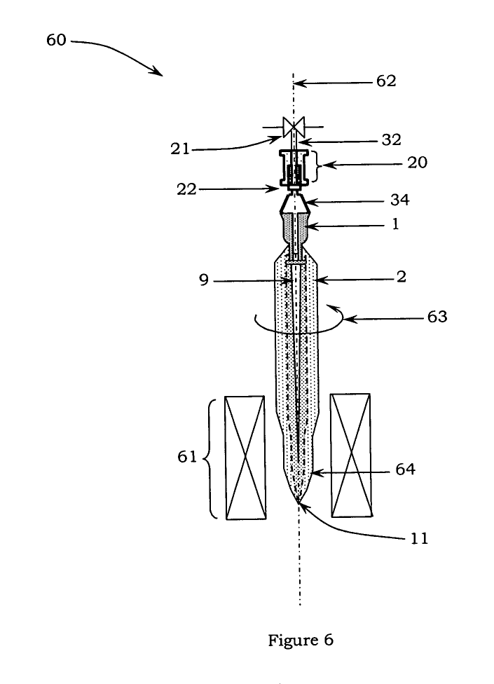

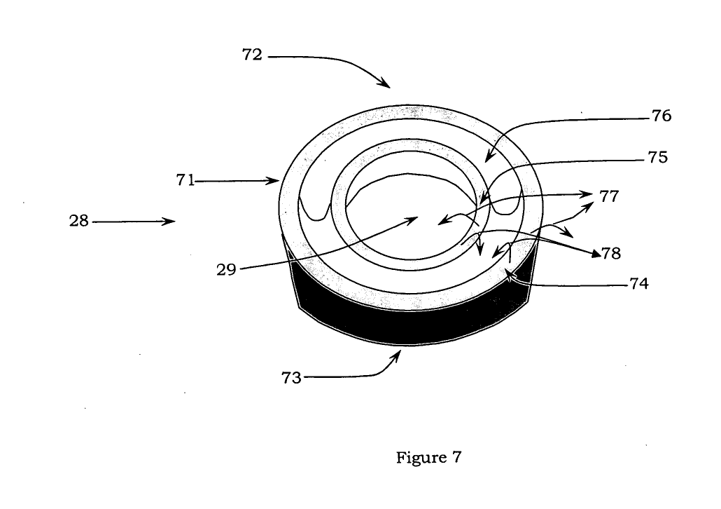

In accordance with preferred embodiment of the present invention, upon removal of cylindrical member 3, hollow soot porous body 2defines a soot porous body having a hcore region 2A and clad region 2B and a capillary 9 [FIG. 1B and FIG. 1C] passing axially through the core region. The hollow soot porous body 2 with capillary 9 is suspended by handle 1 in a sintering furnace 61 [FIG. 6]. The end 11, remote end from handle 1, of the hollow soot porous body 2is fitted with a bottom glass plug 12 prior to positioning hollow soot porous body 2within sintering furnace 61. The bottom glass plug 12 is positioned and held in place with respect to hollow soot porous body 2by friction fit. The bottom glass plug 12 is preferably tapered to facilitate entry and to allow at least temporary affixing and at least loosely within the hollow soot porous body 2.

The hollow soot porous body 2 is preferably chemically dried, for example, by exposing hollow soot porous body 2 to a chlorine-helium containing atmosphere at elevated temperature within sintering furnace 61. The chlorine-helium containing atmosphere removes water and other impurities from hollow soot porous body 2, which otherwise have an undesirable effect on the properties of optical waveguide fiber manufactured from the hollow soot porous body 2.

Following the chemical drying step, the temperature of the sintering furnace 61 is elevated to a temperature sufficient to sinter the hollow soot porous body 2, and preferably to simultaneously collapse the capillary 9 therein to form a solid sintered glass preform. It has been observed that simultaneous sintering and collapsing avoids additional process step thereby result in savings of overall production time of the solid glass preform. Simultaneous sintering of the hollow soot porous body 2 and collapsing of capillary 9 therein also eliminates another disadvantage that occurs when the hollow soot porous body 2 is chemically dried and sintered, and following chemical drying and sintering, the resulting sintered glass preform is exposed to ambient environment, such as ambient atmosphere, for example, when the sintered glass preform is removed from the sintering furnace 61 and moved to a rod draw furnace for further processing steps. The optical fibers manufactured using such preforms have been observed to exhibit high optical attenuation in the ranges varying from about 1310 nm to about 1625 nm. This high attenuation is largely due to contamination of the portion of the sintered glass preform surrounding the capillary 9 prior to collapsing of capillary in rod draw step. The greater the exposure period, the greater the amount of contamination adsorbed by the glass and is proportional to the time period for which the capillary 9 is exposed to the ambient atmosphere. Thus, exposure of capillary 9 of hollow soot porous body 2 or in sintered preform body, to ambient atmosphere is strictly avoided in accordance with preferred embodiment of the present invention. Accordingly, in accordance with preferred embodiment of the method of the present invention, exposure of the capillary 9 to ambient atmosphere is reduced and/or prevented by collapsing the capillary 9 simultaneously in the sintering step.

In another preferred embodiment of the method of the present invention, the simultaneous sintering of the hollow soot porous body 2and collapsing of capillary 9 therein is carried out under the application of negative pressure or vacuum applied through vacuum means [not shown] connected via stationary member 21 [connection to vacuum pump tube] and connecting member 32.

In accordance with present invention, in order to prevent uneven heating and stress generation and distortion in the shape and refractive index profile of the hollow soot porous body 2 during the step of simultaneous sintering and collapsing, not only vacuum is applied, but also the hollow soot porous body 2 is rotated about its longitudinal axis of symmetry 62 preferably in the direction as illustrated by an arrow 63 [FIG. 6].

For achieving vacuum inside the capillary 9 of the rotating hollow soot porous body 2, it is required to be connected to stationary connecting member 32 of the vacuum means [not shown]. As a rotating member 22 [rotating hollow soot porous body 2] cannot be connected directly to stationary member 21 [connecting member 32 of the vacuum means], because such connection will not provide leak-proof connection, a sealing mechanism is essentially required which is capable of maintaining airtight and leak-proof connection between a rotating member 22 and a stationary member 21 in order to maintain the vacuum and avoid contamination with atmospheric contaminants.

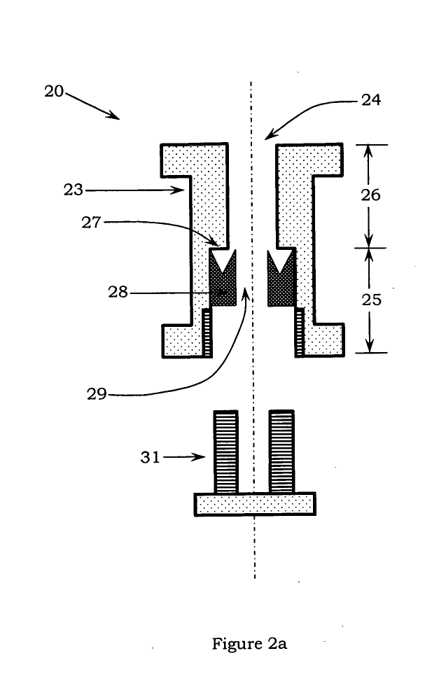

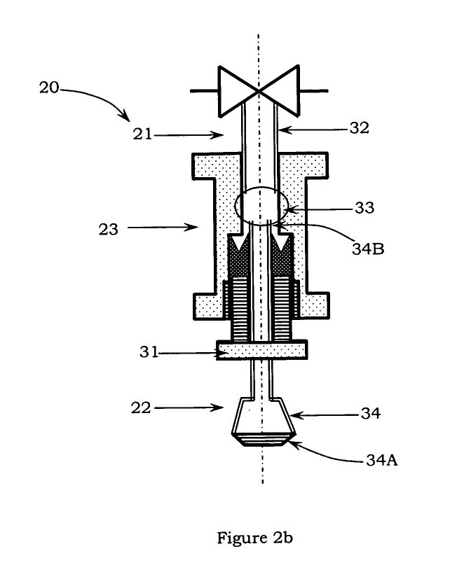

Accordingly, the present invention relates to a rotary seal 20 [FIGS. 2a and 2b] capable of joining a stationary member 21 [connecting member 32 of the vacuum means (not shown in Figures)] with a rotating member 22 [rotating handle 1 of hollow soot porous body 2 or rotating handle of preform tube] comprising a body 23 having a central hole 24 therethrough, wherein said central hole 24 has stepwise reducing diameter so as to form two part 25 and 26 central hole 24, wherein front part 25 of said central hole 24 has higher inner diameter and rear part 26 of said central hole 24 has lower inner diameter, wherein said front part 25 forms a seat 27 with said rear part 26 of said central hole 24, wherein said front part 25 of said central hole 24 is capable of accommodating at least one sealing member 28, and said sealing member 28 is made to sit onto said seat 27 by a screwing member 31, which when fixed onto body 23 fits into front part 25 of said central hole 24, and said rear part 26 of said central hole 24 is capable of accommodating connecting member 32 of said stationary member 21 [connection to vacuum means].

In accordance with present invention, the sealing member 28 has a [central] hole 29 therethrough which essentially has lower inner diameter than the inner diameter of said rear part 26 so that a part 30 of said sealing member 28 projects into said central hole 24 of the rotary seal 20 to provide air-tight sealing between said sealing member 28 of rotary seal 20 and rotating member 22 [rotating handle 1 of hollow soot porous body or rotating handle of preform tube] in front part 25 of said central hole 24 of the rotary seal 20.

It may be noted that merely to avoid confusion with central hole 24 provided in body 23 of rotary seal 20, the hole 29 in the central part of the sealing member is referred 25 to as [central] hole.

In accordance with present invention, the rotary seal 20 is stationary, therefore, it may also be referred to as stationary rotary seal 20.

In accordance with present invention, the length of the sealing member 28 is shorter than the length of front part 25 of said central hole 24 so that the sealing member 28 can be made to sit onto said seat 27 by tightening of screwing member 31.

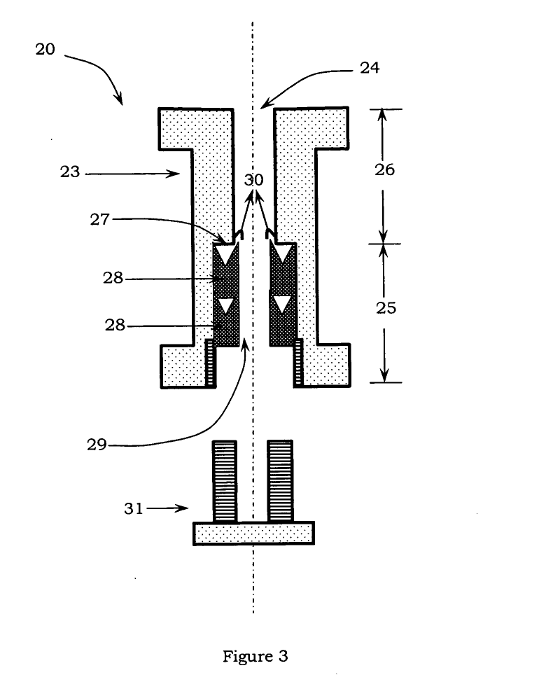

In accordance with one of the preferred embodiments of the present invention, the rotary seal 20 may comprise plurality of sealing members 28, preferably two sealing members 28 [FIG. 3], which has been found to have advantage of increased leak-proof seal between rotating member 22 and sealing member 28 of stationary rotary seal 20.

It may be noted that number of sealing members 28 may vary depending upon the duration and temperature of the process and corrosion conditions of the process wherein the present rotary seal 20 is employed.

In accordance with present invention, the sealing member 28 is provided outside the rotating member 22, and hence the sealing member 28 does not show up inside the rotary sealing mechanism 2l [FIG. 2B], and it remains outside.

In accordance with present invention, the rotating member 22 consists of a connecting means 34 having a handle securing means 34A capable of securing handle 1 of hollow soot porous body 2 and a tubular body 34B passing through the screwing means 31 and the sealing member 28, and covering the sealing member 2828 extends beyond said sealing member 28 to project into said central hole 24.

It may be noted that merely for the ease of understanding, the connecting member 32 of stationary member 21 is referred to as connecting member 32 and connecting member 34 of rotating member 22 is referred to as connecting means 34.

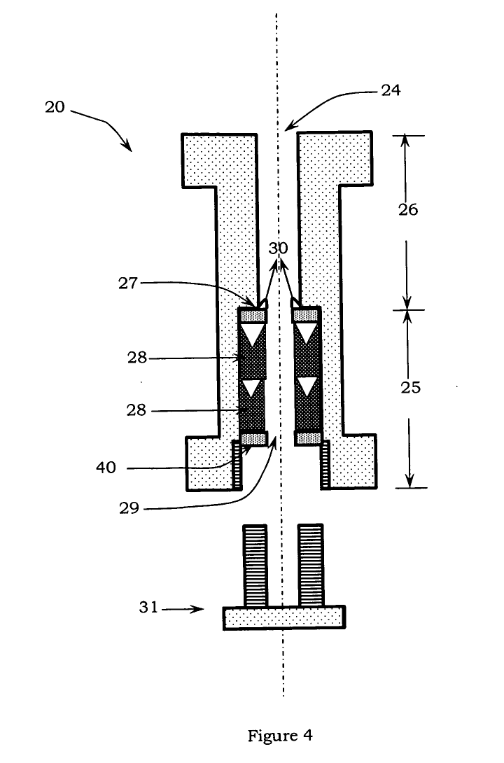

In accordance with another preferred embodiment of the present invention, the sealing members 28 are provided with guiding members 40 on one or both ends thereof, which have been surprisingly found to have advantage of preventing brushing of the sealing members 28 against the seat 27 and screwing member 31. The accompanying FIG. 4 illustrates one of the preferred embodiment of the present invention, wherein sealing members 28 are preferably provided with guiding members 40 on both sides thereof, one towards the seat 27 and another towards the screwing member 31, which have been found to have advantage of preventing brushing of the sealing members 28 against the seat 27 and screwing member 31.

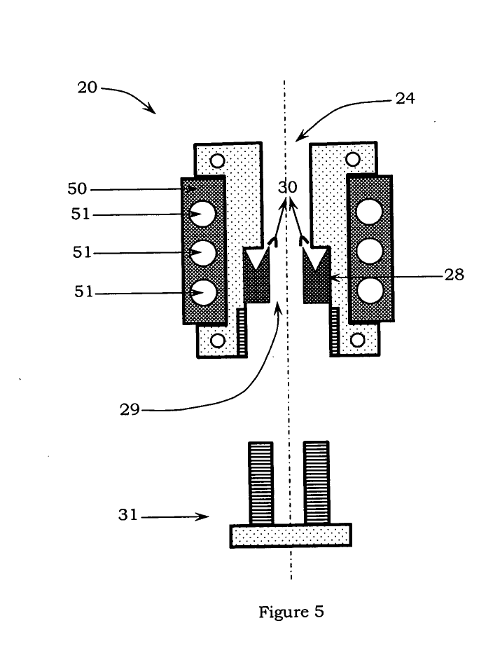

In accordance with still another preferred embodiment of the present invention, the rotary seal 20 is provided with cooling member 50 [FIG. 5] capable of cooling the sealing members 28 in case the same gets heat up under special circumstances, particularly when the process size increases, the temperature of simultaneous sintering and collapsing also increases which may cause heating of the sealing members 28. The cooling member 50 may comprise one or more circular holes 51 surrounding the sealing members 28 so as to achieve cooling of the sealing members 28 for avoiding overheating of sealing members 28, and has advantage of avoiding early wear out of said sealing members due to heating.

In accordance with present invention, the sealing member 28 consists of a lip seal 28 consisting of cylindrical body 71 having bifurcated upper face 72 and lower face 73, wherein said bifurcated upper face 72 consists of outer lip 74 and inner lip 75 forming a groove 76 therebetween and said lower face 73 is preferably flat surface, and having a [central] hole 29 through said body 71 [FIG. 7], wherein said [central] hole 29 essentially has lower inner diameter than the inner diameter of said rear part 26 so that a part 30 of said sealing member 28 projects into said central hole 24 to provide air-tight and leak-proof sealing between stationary rotary seal 20 and rotating member 22 [rotating handle of hollow soot porous body or rotating handle of preform tube] in front part 25 of said central hole 24, and said sealing member 28 is capable of tightly sitting onto said seat 27 by a screwing member 31 [FIGS. 2a and 2b]. The sealing member 28 having bifurcated upper face 72 consisting of outer lip 74 and inner lip 75 forming a groove 76 therebetween has been found to have surprising advantage of its ease of capability of expanding outwardly, as illustrated by arrows 77 on application of pressure when the screwing member 31 is tighten onto the sealing member 28 and its ease of capability of contraction inwardly, as illustrated by arrow 78 on release of pressure when the screwing member 31 is released [FIG. 7].

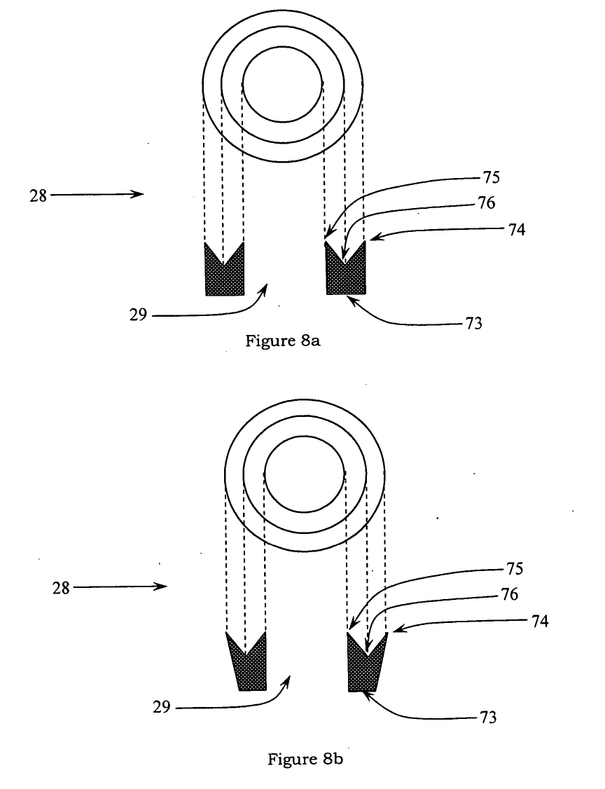

In accordance with one of the preferred embodiments of the present invention, the lip seal 28 has parallel sides [FIG. 8a] or outer sides are tapered and inner sides are parallel [FIG. 8b] which has been found to have advantage of providing airtight and leak-proof seal between the rotating member and stationary member.

In accordance with present invention, the rotary seal 20 consists of locating an end of the rotating member 22 [rotating handle 1 of hollow soot porous body 2or rotating preform tube] inside the front end 25 of the rotary seal 20 [the stationary member] wherein the one or more sealing members 28 are essentially placed between the rotating member 22 and stationary member 20 [rotary seal] so that the sealing members 28 are always outside the rotating member 22 and another end [rear end 26] of rotary seal 20 [stationary member] is then made to fit onto vacuum tube 32 [another stationary member] in a manner that a gap 33 is created between rotating member 22 and second stationary member 32 which has been found to have advantage of immediately removing particles, if any generated on wearing out of the sealing members 28 through the vacuum tube 32 thereby avoiding any contact of particles generated on wearing out of sealing members 28 of the presently disclosed rotary seal 20.

Further, in accordance with present invention, the sealing members 28 are placed between a rotating member 22 and a stationary member 20 contrary to between two rotating members in '069 and such an arrangement of the present rotary seal 20 has been surprisingly found to have advantage of reducing early wearing out of sealing members 28.

Further, in accordance with present invention, the sealing members 28 have one lower flat surface 73 and upper bifurcated surface 72 consisting of two lips 74 and 75 which have been found to have advantage of providing better and improved sealing between the rotating member 22 and stationary member 20 [rotary seal itself].

Further, in accordance with present invention, the sealing members 28 are made to sit in said front part 25 of said central hole 24 of rotary seal 20 against said seat 27 with the help of a screwing means 31 which has been found to have advantage of checking any leakage between the rotating member 22 and stationary member 20 during the on-line process itself. Accordingly, one is not required to stop the process and restart for checking any leakage which may happen on repeated usage of rotary seal.

Accordingly, the presently disclosed rotary seal 20 completely overcomes problem of early wear out of sealing member 28 by connecting one end of rotating member 22 connected to rotating hollow soot porous body 2with one end of stationary member [rotary seal 20], and also overcomes problem of contamination of capillary 9 of hollow soot porous body 2 with particles generated by wearing out of sealing members 28.

As another (rear) end 26 of said stationary member [rotary seal 20] is connected to stationary member 21 [vacuum tube 32] and not to a rotating member, there is no friction, and hence there is no possibility of wearing out of any part of presently disclosed rotary seal.

Accordingly, the connection achieved between stationary member 21 [vacuum tube 32 of the vacuum means] and the rotating member 22 [rotating handle 1 of the hollow soot porous body 2] by presently disclosed rotary seal 20 has been found to overcome all limitations of the rotary seal disclosed in prior art.

Firstly, in accordance with present invention, the sealing member 28 [lip seals] of the present rotary seal 20 is provided between a rotating member 22 [one end of handle 1 of hollow soot porous body 2] and a stationary member, that is front part 25 of rotary seal 20 which has been found to result in reduced friction, and has advantage of reduced, at least reduced early wearing out of the sealing member.

Secondly, if there is any wear out of the sealing member [lip seals], the particles generated on its wearing out are immediately removed through a gap created between rotating member [one end of handle of hollow soot porous body] and a stationary member [vacuum tube] with the help of vacuum being applied therein meaning thereby presently disclosed rotary seal also has advantage of avoiding any contact of particles generated on wearing out of its sealing member with particles of hollow soot porous body and the capillary therein, and hence avoids any increase in the attenuation level of the optical fiber drawn from the preform produced by employing apparatus comprising presently disclosed rotary seal.

In accordance with one of the preferred embodiments of the present invention, a collection member [not shown] may be provided between the vacuum tube and vacuum pump for collecting the particles removed from the rotary seal which has advantage of avoiding direct damage to the vacuum pump.

Thirdly, in accordance with present invention, not only the sealing member is placed outside the rotating member, but the rotary seal is also connected to rotating hollow soot porous body through a handle and is always outside the sintering furnace, accordingly it does not come in direct contact with heat of the sintering furnace meaning thereby it does not experience any wearing out due to heat of the sintering furnace, and hence overcomes associated problems as described hereinabove.

Fourthly, in accordance with present invention, the leakage of sealing between the rotating member and sealing member of the present rotary seal can be checked during on-line production by tightening its screw member which has been found to have advantage of avoiding any leakage of vacuum therein, and hence avoiding contamination of capillary of the hollow soot porous body with contaminants present in the ambient atmosphere because due to on-line checking of leakage, if any the atmospheric contaminants cannot enter the present rotary seal. However, if at all any contaminant enters the present rotary seal, the same is immediately removed due to constant vacuum being applied therein. Accordingly, the present rotary seal also has advantage of avoiding increase in the attenuation level due to contamination of capillary of hollow soot porous body with atmospheric contaminants, and hence makes the preform thus produced suitable for producing the optical fiber which can be used for desired applications.

Fifthly, as in accordance with present invention, the leakage of sealing between the rotating member and sealing member of the present rotary seal can be checked during on-line production by tightening its screw member which has been found to have advantage of avoiding any leakage of vacuum therein, and hence has been found to have advantage of avoiding partial or incomplete closure of capillary and/or formation of bubbles therein.

Sixthly, in accordance with present invention, the inner side and outer side of the cylindrical sealing member of the rotary seal are preferably flat which are capable of forming airtight sealing between the rotating member [one end of handle of hollow soot porous body] and stationary member [sealing member of rotary seal] to achieve complete sealing. Further, the flat inner side of the cylindrical sealing member of the rotary seal has advantage of avoiding friction between rotating member [one end of handle of hollow soot porous body] and stationary member [sealing member of rotary seal], and hence provides smooth rotation of the rotating member, accordingly, present rotary seal has advantage of reduced wearing of its sealing member.

Seventhly, in accordance with present invention, the sealing member is a lip seal having two lips capable of expanding outwardly on application of pressure and contracting inwardly on release of pressure [FIG. 7], wherein said pressure can be easily applied or released by tightening or loosening of screw member of the rotary seal, therefore, it has been found to have advantage of maintaining airtight seal for a longer duration, that is if the seal gets loose it can be tighten by applying pressure by tightening the screw member of the rotary seal while the process is on, meaning thereby present rotary seal not only avoids leakage of atmospheric gases into the capillary of hollow soot porous body, but also avoids probability of abandoning the process resulting in saving of time and material loss.

Therefore, it is understood from the foregoing description that the presently disclosed rotary seal is not only simple and easy to be fabricated, and economical thereby resulting in decrease in cost of apparatus for fabricating preform and hence overall cost of production of optical fiber preform, but also overcomes various disadvantages, drawbacks and limitation of the prior art. The apparatus comprising present rotary seal and the method employing the same have been found to be highly satisfactory and highly economical in-addition to being simple and convenient to operate/perform.

Accordingly, in one embodiment, the present invention also relates to an apparatus 60 for fabricating the preform wherein the apparatus comprises present rotary seal 20.

Accordingly, in another embodiment, the present invention also relates to a method for fabricating the preform employing the apparatus comprising present rotary seal 20.

It may be noted that the accompanying Figures are not drawn to scale.

In one exemplary embodiment, after completion of soot deposition, the soot porous body is detached from the lathe along with the handle 1 [FIG. 1B and FIG. 1C]. Thereafter, the cylindrical member 3 is removed from the soot porous body, forming a capillary 9 therethrough as hereinabove described [FIG. 1C].

Thus obtained hollow soot porous body 2having a capillary 9 is then transferred to the sintering furnace 61 [FIG. 6] along with the handle 1. In the sintering furnace the hollow soot porous body 2 is sintered and collapsed simultaneously to give a solid glass preform.

The hollow soot porous body handle 1 is made to fit into or onto the member 34 depending upon the relative diameter of these two members and the hollow soot porous body 2 is suspended in the sintering furnace 61. Preferably the member 34 is made of a non-corrosive and has very high melting point material, typically more than 1800° C. The connecting means 34 consists of handle securing means 34A capable of securing handle 1 of hollow soot porous body 2 and a tubular body 34B passing through the screwing means 31 and the sealing member 28, and covering the sealing member 28 extends beyond said sealing member 28 to project into said central hole 24.

In accordance with one of the preferred embodiments of the present invention, sealing members are made of rubber (or any material which is elastic) and have a ring shape structure, and the bifurcated surface is always placed in a manner so that the pressure of the fluid (gas or vacuum or liquid) is always on this surface. Due to pressure, as stated hereinabove, the bifurcated surface lips 74 and 75 move apart from each other [arrows 77, FIG. 7] and grip the surfaces of the body in contact more tightly. Accordingly, the present rotary seal provide complete sealing. Therefore, the presently disclosed rotary sealing mechanism has following advantage over the O-rings (solid rubber rings) as known in the art:
1. The O-rings hold only one end or one contacting surface onto which it is fitted whereas, on the contrary the present rotary seal having a lip seal consisting of bifurcated top surface contacts both the contacting surfaces tightly.
2. As the pressure on the bifurcated top surface increases by tightening of screwing means, the sealing member of present rotary seal holds both the contacting surfaces more tightly.
3. The sealing member of present rotary seal allows smooth rotation of rotating member without much friction due to presence of bifurcated top surface which has been found to have capability of ease of expansion and contraction. Accordingly, the lips of top surface though contact and hold both the surfaces tightly but allow rotation of rotating member by spring action.

The connection between the hollow soot porous body handle 1 and the member end 34A is made rigid and leak proof, either by threading or use of sealant suitable for operating in corrosive and high temperature environments.

In accordance with one of the preferred embodiments of the present invention, the body and screwing member are made of a material that is typically non-corrosive and high temperature resistant selected from a group comprising stainless steel, ceramic, glass material, polyurethane and polyethylene with cooling systems.

In accordance with one of the preferred embodiments of the present invention, the member 34 is made of a material selected from a group comprising stainless steel of high quality, glass, ceramic with high melting point, and polyurethane with cooling fluid circulation.

In accordance with one of the preferred embodiments of the present invention, the connecting member [vacuum tube] is capable of withstanding high temperatures and is corrosion free. The connection of the rotary sealing mechanism 20 and the vacuum tube 32 can be made in usual way, either by threading or any other known leak proof methods.

As described herein the capillary end 11 remote from the handle 1 is closed with a glass plug 12. With this the setup [FIGS. 1B, 2B and 6] comprising hollow soot porous body 2, member 34, rotary sealing mechanism 20 and vacuum pump (not shown), wherein the hollow soot porous body 2 is provided with glass plug 12 at the end 11 is inserted into the sintering furnace 61 at a predetermined speed. The hollow soot porous body 2 is chemically dried at a first drying temperature as described herein. Thereafter, the temperature of the sintering furnace 61 is increased and the tip 64 of the hollow soot porous body 2 is sintered, so that the hollow soot porous body 2contracts and engages glass plug 12 fitted at the end 11 of the hollow soot porous body 2. After this step of engaging the glass plug 12, the vacuum is applied to the capillary 9 of the hollow soot porous body 2. Sintering furnace 61 temperature is maintained high enough to soften the glass, which is suitable to collapse the capillary 9 of hollow soot porous body. Typically this temperature is in the range varying from about 1550 to about 1650° C. The care is taken that this temperature is higher than the temperature, which is required just for sintering the hollow soot porous body.

To prevent deformation in shape and refractive index profile of the hollow soot porous body 2, in accordance with the present invention, the hollow soot porous body, is rotated at predetermined speed preferably in the direction indicated by arrow 63. It may be noted that in accordance with present invention, the hollow soot porous body 2 connected to the member 34 rotates while the rotary sealing mechanism 20 remains stationary. As described herein above, the end 34B having smooth outside surface to avoid friction, slides over the sealing members 28 and extends beyond the sealing member 28 to form a gap 33 with connecting member 32. The screwing means 31 of the rotary sealing mechanism 20 is tightened in such a manner that the sealing members 28 expands on to the tubular part 34B of the member 34, so as to form airtight and leak-proof seal therebetween the two—sealing members 28 and tubular part 34B of member 34. As described herein, the present rotary seal 20 having a screwing member 31 has advantage that the screwing member 31 can be adjusted even on-line, that is during the process of sintering and collapsing. Accordingly, if any leakage takes place, the same can be checked on-line without stopping the on-going process.

The process is continued in the manner as described hereinabove till the solid glass preform is prepared, which is removed and subjected to fiber draw process in a conventional manner either directly from mother preform or via drawing core rods, i.e. from daughter preform, wherein the fiber has been found to have attenuation losses well below the desired values of about 0.34 dB/nm at about 1310 nm and about 0.20 dB/Km at about 1550 nm.

Accordingly, in one embodiment, the present invention also relates to an optical fiber preform produced by apparatus comprising presently disclosed rotary sealing mechanism, wherein the optical fiber preform does not has contaminated centerline.

Accordingly, in another embodiment, the present invention also relates to an optical fiber produced from an optical fiber preform produced by apparatus comprising presently disclosed rotary sealing mechanism.

The present invention is now described with reference to following examples which are not intended to limit scope of this invention.

### EXAMPLE 1

A hollow soot porous body with outer diameter of 170 mm and having a capillary at the center of about 4 mm (after removing the cylindrical member) was fabricated by ACVD process. This hollow soot porous body was fitted with glass plug at the capillary end remote from the handle. The hollow soot porous body handle was fitted with rotary sealing mechanism having no cooling system in accordance with one of the preferred embodiments of the present invention. It was dried in an atmosphere of chlorine and helium at a temperature of 1000° C. Then the end of the capillary remote from the handle of the preform fitted with a glass plug was heated to a temperature of 1550° C. to cause engagement of glass plug. Thereafter, a vacuum of about 550 mm Hg was applied to the capillary, through the rotary sealing mechanism of present invention. The hollow soot porous body was inserted at an insertion speed of 4.5 mm/min in the sintering furnace. While heating the hollow soot porous body was rotated at a speed of 2.5 rpm (revolutions per minute) and sintered into a solid glass preform. The glass preform also known as mother preform was then drawn into 5 numbers of rods. These rods were further processed to form daughter preforms. A fiber was drawn from one of the daughter preforms. The attenuation values for the optical fiber thus drawn are shown in Table I below. It is observed that the attenuation losses for the optical fiber drawn by an apparatus comprising rotary sealing mechanism of present invention employing presently disclosed process are well below the desired values of 0.34 dB/Km at 1310 nm and 0.20 dB/Km at 1550 nm confirming that the presently disclosed rotary sealing mechanism worked satisfactorily without causing any release of particles from sealing members, and leakage of vacuum from rotary sealing mechanism and contamination of capillary of hollow soot porous body with atmospheric contaminants during the entire process of preparation of preform. After completion of the process, the sealing members were also checked and found in good condition and suitable for further use.

The results of this example confirms that the presently disclosed rotary sealing mechanism is suitable for achieving airtight and leak-proof contact between rotating member [rotating hollow soot porous body] and stationary member [connection to vacuum pump].

TABLE I

| Sr. No. | Wavelength (nm) | Loss (dB/Km) |
|---|---|---|
| 1 | 1310 | 0.332 |
| 2 | 1550 | 0.191 |
| 3 | 1383 | 0.315 |

### EXAMPLE 2

The method for fabricating the preform and drawing a fiber therefrom was followed as described in Example 1 above. However, the rotary sealing mechanism of U.S. patent '069 was employed for achieving contact between rotating member [rotating hollow soot porous body] and stationary member [connection to vacuum pump]. The attenuation values for the optical fiber drawn by an apparatus emptying rotary sealing mechanism of US '069 are shown in Table II below. It is observed that the attenuation losses for the optical fiber drawn by an apparatus comprising rotary sealing mechanism of US '069 are well above the desired values of 0.34 dB/Km at 1310 nm and 0.20 dB/Km at 1550 nm confirming that the rotary sealing mechanism of US '069 does not work satisfactorily and causes any release of certain particles from its sealing members [the O-rings], and leakage of vacuum from rotary sealing mechanism and contamination of capillary of hollow soot porous body with atmospheric contaminants during the process of preparation of preform. After completion of the process, the sealing members [the O-rings] were also checked and were not found in good condition and suitable for further use, because the same got ruptured. Further, upon examination, it was also observed that the capillary of the hollow soot porous body could not get completely collapsed due to loss of vacuum during the process. Accordingly, the partially collapsed preform was produced which resulted in production of undesired fiber.

TABLE II

| Sr. No. | Wavelength (nm) | Loss (dB/Km) |
|---|---|---|
| 1 | 1310 | 0.450 |
| 2 | 1550 | 0.262 |
| 3 | 1383 | 0.523 |

The presently disclosed rotary sealing mechanism described herein above has been used for connecting the stationary vapor supply tube and the rotary deposition tube in modified chemical vapor deposition (MCVD) process as well. The deposition silica glass tube was connected instead of member 34 in the above-described process, whereas the chemical delivery tube is connected to that end of rotary sealing mechanism, which has been observed to hold the vacuum connection satisfactorily. It was observed that no leakages of chemical vapor occurred during the completed process of fabrication of the core rod by the modified chemical vapor deposition method confirming suitability of present rotary sealing mechanism for MCVD process.

It may be noted that the rotary sealing mechanism of the present invention can also be used to collapse the capillary in the preform in any stage i.e., the hollow soot porous body can be sintered without collapsing the capillary first and then in next step subjecting the preform to a temperature higher than sintering temperature can collapse the capillary while applying vacuum to the capillary. It may also be noted that during the collapsing step the preform is rotated about the longitudinal axis at a predetermined speed to cause uniform collapsing of the capillary and to avoid the deformation of shape of the sintered preform. Thus, in order to rotate the preform and apply vacuum or negative pressure to the capillary the present rotary sealing mechanism is used and ahs been found suitable.

The capillary in the sintered preform can be collapsed in the step of rod draw, where the preform is drawn into rods with smaller diameter (called daughter preform) than the sintered preform (also called mother preform). Here also the preform has to be rotated, while applying negative pressure to the capillary, about the longitudinal axis of symmetry to allow symmetric collapse of capillary and avoid stress formation in the rods drawn. The rotary sealing mechanism of the present invention has also been found to be suitable for collapsing the capillary in the rod draw step.

It may be noted that the rotary sealing mechanism of the present invention has also been found suitable for collapsing the capillary during sintering and also for the rod draw process steps.

It may also be noted that the rotary sealing mechanism may be modified to suit any other process for fabricating an optical fiber preform without deviating from the scope of the present invention. Therefore, such modifications of the presently disclosed rotary sealing mechanism are intended within the scope of present invention.

The word “about” as used herein is intended to include the practical errors in achieving the respective value of any of the respective parameter referred therein.

Although specific terms are employed herein, they are used in a generic and descriptive sense only and not for purpose of limitation.

1. A rotary seal capable of joining a stationary member with a rotating member comprising a body having a central hole therethrough, wherein said central hole has stepwise reducing diameter so as to form two part central hole, wherein front part of said central hole has higher inner diameter and rear part of said central hole has lower inner diameter, wherein said front part forms a seat with said rear part of said central hole, wherein said front part of said central hole is capable of accommodating at least one sealing member, and said sealing member is made to sit onto said seat by a screwing member, which when fixed onto said body fits into front part of said central hole, and said rear part of said central hole is capable of accommodating connecting member of said stationary member.

2. A rotary seal as claimed in claim 1, wherein said sealing member has a [central] hole therethrough which essentially has lower inner diameter than inner diameter of said rear part so that a part of said sealing member projects into said central hole of rotary seal to provide air-tight sealing between said sealing member of stationary rotary seal and rotating member in front part of said central hole of rotary seal.

3. A rotary seal as claimed in claim 1, wherein said sealing member consists of a lip seal.

4. A rotary seal as claimed in claim 3, wherein said lip seal consists of cylindrical body having bifurcated upper face and flat lower face, and having a [central] hole through said body.

5. A rotary seal as claimed in claim 4, wherein said bifurcated upper face consists of outer lip and inner lip forming a groove therebetween to have ease of outward expansion on application of pressure and ease of inward contraction on release of pressure for achieving better and improved sealing between said rotating member and said rotary seal.

6. A rotary seal as claimed in claim 5, wherein said pressure is applied or released by said screwing member.

7. A rotary seal as claimed in claim 1, wherein length of said sealing member is shorter than a length of said front part of said central hole so that said sealing member can be made to sit onto said seat by tightening of said screwing member.

8. A rotary seal as claimed in claim 1, wherein said rotary seal may comprise plurality of said sealing members for achieving increased leak-proof seal between said rotating member and said sealing member of stationary rotary seal.

9. A rotary seal as claimed in claim 8, wherein said sealing members are two in number to achieve increased leak-proof seal between said rotating member and said sealing member of stationary rotary seal.

10. A rotary seal as claimed in claim 9, wherein number of said sealing members may vary depending upon duration and temperature of the process and corrosion conditions of the process wherein said rotary seal is employed.

11. A rotary seal as claimed in claim 1, wherein said sealing members are provided with guiding members for preventing brushing of said sealing members against said seat and said screwing member.

12. A rotary seal as claimed in claim 11, wherein said sealing members are provided with guiding members on at least one end thereof.

13. A rotary seal as claimed in claim 1, wherein said rotary seal is provided with cooling member for achieving cooling of said sealing members.

14. A rotary seal as claimed in claim 13, wherein said cooling member comprises at least one circular hole surrounding said sealing members for achieving cooling of said sealing members for avoiding early wear out of said sealing members due to heating.

15. A rotary seal as claimed in claim 3, wherein said lip seal has parallel sides.

16. A rotary seal as claimed in claim 3, wherein outer sides of said lip seal are tapered and inner sides are parallel to have airtight and leak-proof seal between said rotating member and stationary member.

17. A rotary seal as claimed in claim 1, wherein said sealing members are provided outside said rotating member.

18. A rotary seal as claimed in claim 1, wherein said rotating member consists of a connecting means having a handle securing means capable of securing handle of hollow soot porous body and a tubular body passing through said screwing means and said sealing member, and covering said sealing member extends beyond said sealing member to project into said central hole.

19. A rotary seal as claimed in claim 1, wherein said connecting member of said stationary member and said tubular body of said rotating member form a gap in said central hole for achieving immediate removal of particles generated on wearing out of said sealing members.

20. A rotary seal as claimed in claim 1, wherein said screwing means are capable of checking leakage between said rotating member and said sealing member of stationary rotary seal during on-line process.

21. A rotary seal as claimed in claim 1, wherein a collection member is provided between said connecting member and vacuum means for collecting the particles removed from the rotary seal.

22. An apparatus for fabricating a preform, wherein said apparatus comprises rotary seal as claimed in claim 1.

23. A method for fabricating a preform employing the apparatus comprising rotary seal as claimed in claim 1.

24. An optical fiber preform as and when produced by apparatus comprising rotary seal as claimed in claim 1, wherein said optical fiber preform does not have a contaminated centerline.

25. An optical fiber as and when produced from optical fiber preform as claimed in claim 24, wherein said fiber has attenuation losses less than about 0.34 dB/Km at about 1310 nm and less than about 0.20 dB/Km at about 1550 nm.
